(19) United States
(12) Patent Application Publication
(10) Pub. No.: US 2025/0237614 A1
(43) Pub. Date: Jul. 24, 2025

(54) APPARATUS AND METHOD FOR MEASURING DEFECT IN MOLDED PRODUCT SURFACE

(71) Applicant: ELECTRONICS AND TELECOMMUNICATIONS RESEARCH INSTITUTE, Daejeon (KR)

(72) Inventors: Yong Kwi LEE, Daejeon (KR); Chang Beom KIM, Daejeon (KR); Hyun Chul KANG, Daejeon (KR); Ji Yeon SON, Daejeon (KR)

(73) Assignee: ELECTRONICS AND TELECOMMUNICATIONS RESEARCH INSTITUTE, Daejeon (KR)

(21) Appl. No.: 19/029,960

(22) Filed: Jan. 17, 2025

(30) Foreign Application Priority Data
Jan. 19, 2024 (KR) 10-2024-0008855
Dec. 19, 2024 (KR) 10-2024-0191866

(51) Int. Cl. G01N 21/88; B29C 37/00; B29L 31/00; G06T 7/00; H04N 23/56; H04N 23/62; H04N 23/74

(52) U.S. Cl. CPC G01N 21/8806; B29C 37/00; G06T 7/001; H04N 23/56; H04N 23/62; H04N 23/74; B29C 2037/903; B29C 2037/906; B29L 2031/7622; G06T 2207/10148; G06T 2207/10152; G06T 2207/20081; G06T 2207/30108

(57) ABSTRACT

The present invention relates to a molded product surface defect measuring apparatus, which includes a sensor module configured to detect a signal for performing a door closing/opening event or a lighting-on/off event of the molded product surface defect measuring apparatus, a lighting module configured to emit light required for measuring a defect in a surface of a molded product, a camera module configured to photograph the surface of the molded product, and a processor configured to control the lighting module and the camera module to perform the measuring of the defect in the surface of the molded product.

### CROSS-REFERENCE TO RELATED APPLICATION

This application claims priority to and the benefit of Korean Patent Application No. 10-2024-0008855, filed on Jan. 19, 2024, and Korean Patent Application No. 10-2024-0191866, filed on Dec. 19, 2024, the disclosures of which are incorporated herein by reference in their entirety.

### BACKGROUND

### 1. Field of the Invention

The present invention relates to an apparatus and method for measuring a defect in a molded product surface that are capable of measuring a defect in a molded product surface, which is generated during a molding process in a production line in a factory, according to objective criteria.

### 2. Discussion of Related Art

In many small and medium-sized factories in Korea, numerous molding processes including plastic molding, sheet metal molding, shape molding, and the like are performed,

Among molded products, there are cases in which surfaces are formed unevenly after molding.

In a case in which there are defects in surfaces after molding, there are many cases in which all other parts that have been input during subsequent processes are damaged, resulting in losses.

However, currently, the quality inspection to determine whether a molded product surface is normal or not is visually performed by workers while light is emitted on the molded product surface. That is, since the workers subjectively determine whether the molded product surface is defective, it is causing great damage in subsequent processes.

Therefore, there is a need for a method that enables a worker to measure a defect in a surface of a molded product (e.g., an inner box of a refrigerator) according to objective criteria instead of his/her experience or subjective determination.

### SUMMARY OF THE INVENTION

The present invention is directed to providing an apparatus and method for measuring a defect in a molded product surface that are capable of measuring a defect in a molded product surface, which is generated during a molding process in a production line in a factory, according to objective criteria.

According to an aspect of the present invention, there is provided a molded product surface defect measuring apparatus, which includes a sensor module configured to detect a signal for performing a door closing/opening event or a lighting-on/off event of the molded product surface defect measuring apparatus, a lighting module configured to emit light required for measuring a defect in a surface of a molded product, a camera module configured to photograph the surface of the molded product, and a processor configured to control the lighting module and the camera module to perform the measuring of the defect in the surface of the molded product.

The product may be input into the molded product surface defect measuring apparatus by a robot, a machine, or a facility.

When the product is completely input into the molded product surface defect measuring apparatus and a door of the molded product surface defect measuring apparatus is closed, the molded product surface defect measuring apparatus may receive a door closing event signal from the sensor module and control the lighting module.

When the product is completely input into the molded product surface defect measuring apparatus, the processor may control the lighting module and the camera module to emit light on the surface of the molded product, photograph the surface of the molded product using one or more cameras, extract data, and at the same time, determine whether the surface of the molded product is normal or abnormal through data analysis.

The processor may perform a lighting-on function of the lighting module to support the photographing of the camera module by emitting light on an inner surface of the product, activate a surface defect inspection function, and operate the camera module to adjust a focus of each camera.

In order to adjust the focus of each camera, the processor may receive a predetermined button of a keyboard from a user as an input or activate the surface defect inspection function, and at the same time, automatically operate a camera focus adjustment function.

When adjustment of a focus of each camera of the camera module is completed and a scratch is detected from the product, the processor may control the scratch to be more clearly photographed by adjusting an angle of each camera or adjusting light brightness through a lighting brightness adjustment function for distinguishing a sharpness of the scratch.

The lighting brightness adjustment function for distinguishing the sharpness of the scratch may be a function for adjusting the light brightness in order to ensure that a camera image of the scratch is captured well, and may be a function in which the processor uses a dimming function of lighting to find an optimal illuminance value by increasing the light brightness by a predetermined unit brightness starting from a predetermined default brightness up to a maximum brightness.

The processor may collect image data through the camera module, then perform normal data learning to generate an image data model that extracts abnormal data and compare a plurality of pieces of image data newly input to the image data model through an image data model comparison function to determine whether the molded product surface is normal or abnormal.

The processor may display an abnormality on a monitoring device so that a worker performs a product check and determination process when it is determined that the molded product surface is abnormal through the image data model comparison operation, and terminates the inspection process when it is determined that the molded product surface is normal, wherein when displaying the abnormality on the monitoring device, the processor displays a location of the defect with a predetermined color in a region in which the abnormality has occurred so that the worker visually recognizes rapidly and easily where and what type of defect has occurred in the product.

In the lighting module, in order to prevent a light scattering phenomenon of lighting from being mis-recognized as the defect in the molded product surface when the defect in the surface of the molded product is measured, a bulb-type light and a directional light may be used together.

According to another aspect of the present invention, there is provided a molded product surface defect measuring method, which includes detecting by, a processor of a molded product surface defect measuring apparatus, a signal for performing a door closing/opening event or a lighting-on/off event of the molded product surface defect measuring apparatus using a sensor module, and controlling a lighting module and a camera module to perform measurement of a defect in a surface of a molded product when the signal is detected using the sensor module.

In the controlling of the lighting module, when the product is completely input into the molded product surface defect measuring apparatus and a door of the molded product surface defect measuring apparatus is closed, the processor may receive a door closing event signal from the sensor module and control the lighting module.

When the product is completely input into the molded product surface defect measuring apparatus, the processor may control the lighting module and the camera module to emit light on the surface of the molded product, photograph the surface of the molded product using one or more cameras, extract data, and at the same time, determine whether the surface of the molded product is normal or abnormal through data analysis

In the controlling of the lighting module and the camera module, the processor may perform a lighting-on function of the lighting module to support the photographing of the camera module by emitting light on an inner surface of the product, activate a surface defect inspection function, and operate the camera module to adjust a focus of each camera.

In order to adjust the focus of each camera, the processor may receive a predetermined button of a keyboard from a user as an input or activate the surface defect inspection function, and at the same time, automatically operate a camera focus adjustment function.

When adjustment of a focus of each camera of the camera module is completed and a scratch is detected from the product, the processor may control the scratch to be more clearly photographed by adjusting an angle of each camera or adjusting light brightness through a lighting brightness adjustment function for distinguishing a sharpness of the scratch.

The lighting brightness adjustment function for distinguishing the sharpness of the scratch may be a function for adjusting the light brightness in order to ensure that a camera image of the scratch is captured well, and may be a function in which the processor uses a dimming function of lighting to find an optimal illuminance value by increasing the light brightness by a predetermined unit brightness starting from a predetermined default brightness up to a maximum brightness.

In the controlling of the lighting module and the camera module to perform the measurement of the defect in the surface of the molded product, the processor may collect image data through the camera module, then perform normal data learning to generate an image data model that extracts abnormal data, and compare a plurality of pieces of image data newly input to the image data model through an image data model comparison function to determine whether the molded product surface is normal or abnormal.

In the controlling of the lighting module and the camera module to perform the measurement of the defect in the surface of the molded product, the processor may display an abnormality on a monitoring device so that a worker performs a product check and determination process when it is determined that the molded product surface is abnormal through the image data model comparison operation, and terminates the inspection process when it is determined that the molded product surface is normal, wherein when displaying the abnormality on the monitoring device, the processor displays a location of the defect with a predetermined color in a region in which the abnormality has occurred so that the worker visually recognizes rapidly and easily where and what type of defect has occurred in the product.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is an exemplary diagram illustrating a schematic configuration of a molded product surface defect measuring apparatus according to one embodiment of the present invention;

FIG. 2 is a flowchart for describing a molded product surface defect measuring method according to one embodiment of the present invention;

FIG. 3 is an exemplary diagram showing a plurality of camera output screens according to the molded product surface defect measuring method in FIG. 2;

FIG. 4 is a flowchart for describing detailed operations of performing a lighting brightness adjustment function for distinguishing a sharpness of a scratch in FIG. 2;

FIG. 5 is an exemplary diagram showing test results for determination performance of an abnormal data extraction model according to the present embodiment;

FIG. 6 is an exemplary diagram showing a screen on which a location of a defect is displayed in an abnormal region of the molded product surface with a predetermined color according to the present embodiment;

FIGS. 7A and 7B are a set of exemplary diagrams showing shapes of a device of the molded product surface defect measuring apparatus (i.e., an inspector) according to the present embodiment in FIG. 1;

FIG. 8 is an exemplary diagram showing a double-locking latch device for closing and locking a door of a molded product surface defect measuring apparatus (i.e., an inspector) according to one embodiment of the present invention;

FIGS. 9A to 9C are a set of exemplary diagrams showing views at respective locations in a state in which the door of the molded product surface defect measuring apparatus (i.e., the inspector) is closed and a sample is input according to one embodiment of the present invention;

FIG. 10 is an exemplary diagram showing the shape of the device of the molded product surface defect measuring apparatus in more detail in FIGS. 7A and 7B;

FIG. 11 is an exemplary picture showing a scene in which a defect in a surface of an actual molded product is measured in FIGS. 7A and 7B;

FIGS. 12A to 12C are a set of exemplary pictures showing a phenomenon in which emitted light spreads when a defect in a surface of a molded product is measured;

FIGS. 13A to 13C are a set of exemplary pictures at multiple angles showing scenes in which light emitting-diode (LED) lights attached to a scratch inspection device emit light to the inside of the product in FIG. 10; and

FIG. 14 is an exemplary diagram showing a location of a scratch inspection device to take a picture inside a refrigerator in FIG. 10.

### DETAILED DESCRIPTION OF EXEMPLARY EMBODIMENTS

Hereinafter, examples of an apparatus and method for measuring a defect in a molded product surface according to embodiments of the present invention will be described.

In this process, thicknesses of lines, sizes of components, and the like shown in the accompanying drawings may be exaggerated for clarity and convenience of description. Further, some terms which will be described below are defined in consideration of functions in the present invention and meanings may vary depending on, for example, a user or operator's intentions or customs. Therefore, the meanings of these terms should be interpreted based on the scope throughout this specification.

Hereinafter, embodiments of the present invention will be described in detail with reference to the accompanying drawings so that the embodiments can be easily performed by those skilled in the art. However, embodiments of the present invention may be implemented in several different forms and are not limited to embodiments described herein. In addition, parts irrelevant to description are omitted in the drawings in order to clearly explain embodiments of the present invention. Similar parts are denoted by similar reference numerals throughout this specification.

Throughout this specification, when a certain part “includes” a certain component, it means that another component may be further included rather than other components being excluded unless otherwise stated.

Implementations described herein may be implemented, for example, as a method, a process, a device, a software program, a data stream, or a signal. Although discussed only in the context of a single form of implementation (e.g., only as a method), implementations of the features discussed may also be implemented in other forms (e.g., devices or programs). The device may be implemented as appropriate hardware, software, firmware, etc. The method may be implemented in a device such as a processor, which is generally a processing device including a computer, microprocessor, integrated circuit, or programmable logic device.

Generally, in a molding process, when there is the quality of the surface of a portion that a customer directly touches after molding, the quality of the surface is linked to the image of the entire brand of the product and affects the overall brand image. Therefore, the quality of the surface that the consumer directly touches should be thoroughly managed.

However, when a worker visually inspects a molded product surface, the worker may miss a defect in the molded product surface, and because the worker has to directly see and determine hundreds of products (e.g., refrigerators) produced each day, physical and mental fatigue can reduce overall work efficiency.

Therefore, the present invention provides a method in which the existing method of subjectively determining the quality of a molded product surface by a worker can be improved so that a defect in the molded product surface can be objectively determined regardless of the worker. The present invention provides a technology in which light is emitted on a surface of a molded product, the surface of the molded product can be photographed using one or more cameras, and at the same time, whether the surface of the molded product is normal or abnormal can be determined through data analysis.

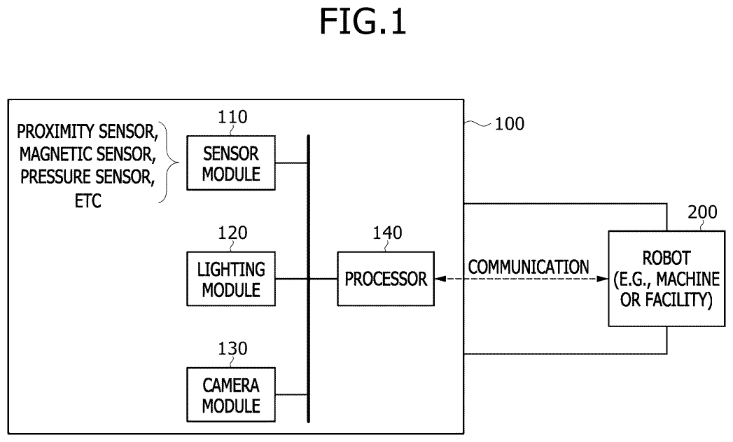

FIG. 1 is an exemplary diagram illustrating a schematic configuration of a molded product surface defect measuring apparatus 100 according to one embodiment of the present invention.

As illustrated in FIG. 1, the molded product surface defect measuring apparatus 100 according to the present embodiment includes a sensor module 110, a lighting module 120, a camera module 130, and a processor 140.

The sensor module 110 detects a signal for performing a door closing/opening event of a product (e.g., a refrigerator), a lighting-on/off event, or the like.

For example, the sensor module 110 may include a proximity sensor, a magnetic sensor, a pressure sensor, etc.

The lighting module 120 includes at least one light that emits light required for inspection (i.e., defect measurement) of a surface of the molded product (e.g., the refrigerator).

The camera module 130 includes at least one camera for photographing the surface of the molded product (e.g., the refrigerator).

The processor 140 controls the lighting module 120 and the camera module 130 on the basis of the signal detected through the sensor module 110 to perform inspection (i.e., the defect measurement) on the surface of the molded product (e.g., the refrigerator).

The molded product surface defect measuring apparatus 100 may input the product (e.g., the refrigerator) into the molded product surface defect measuring apparatus 100 by a robot 200 (e.g., a machine or a facility).

The robot 200 may be controlled through communication with the processor 140 or may be controlled by a separate external robot controller (not illustrated).

The robot 200 may open a door (not illustrated) of the molded product surface defect measuring apparatus 100 and input the product (e.g., the refrigerator) thereinto. In this case, a person may intervene, and when the input of the product is completed, the robot 200 may close the door (not illustrated) of the molded product surface defect measuring apparatus 100.

When the product is input into the molded product surface defect measuring apparatus 100, the processor 140 controls the lighting module 120 and the camera module 130 to emit light on the surface of the molded product, photograph the surface of the molded product using at least one camera, extract data, and at the same time, determine whether the surface of the molded product is normal or abnormal through data analysis.

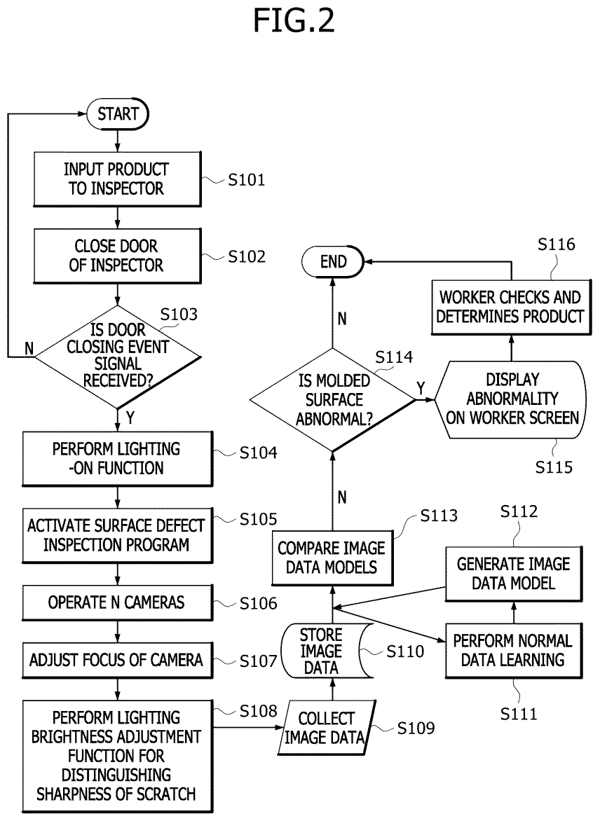

FIG. 2 is a flowchart for describing a molded product surface defect measuring method according to one embodiment of the present invention.

Referring to FIG. 2, a robot 200 opens a door of a molded product surface defect measuring apparatus 100 (hereinafter simply referred to as an “inspector”), inputs a product, and closes the door (S101 and S102).

In this case, the product may be manually input by a person or may be input using a machine or a facility during a production process.

The processor 140 receives a door closing event signal through the sensor module 110.

When the door closing event signal is received (Yes in S103), the processor 140 controls the lighting module 120.

The processor 140 performs a lighting-on function of the lighting module 120 to support the photographing of the camera module 130 by emitting light on an inner surface of the product (S104).

The processor 140 activates a surface defect inspection program (function) (S105).

The processor 140 operates a plurality of cameras (i.e., n cameras) (S106) and then adjusts a focus of each camera (S107).

For example, since a proximity distance to a molded product surface is different depending on an orientation of each camera, it is necessary to adjust the focus of each camera.

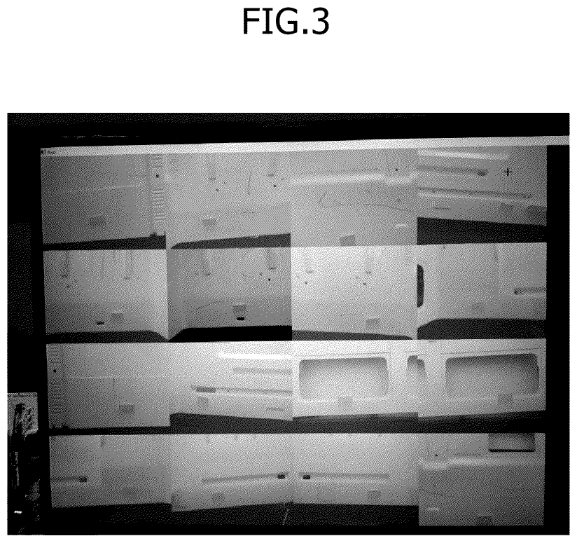

FIG. 3 is an exemplary diagram showing a plurality of camera output screens according to the molded product surface defect measuring method in FIG. 2.

In this case, images captured by the plurality of cameras (i.e., n cameras) may be displayed on a monitoring device (e.g., a user monitor) (not illustrated) through the surface defect inspection program (function), as illustrated in FIG. 3.

For example, as illustrated in FIG. 3, images captured by a total of 16 cameras (e.g., eight upper cameras and eight lower cameras) may be collected and displayed on the monitoring device (e.g., the user monitor).

The processor 140 controls the plurality of cameras (i.e., n cameras) simultaneously through a camera focus adjustment function to adjust a focus of each camera at its own location.

In this case, the camera focus adjustment function may be configured to instruct a user to adjust the focus of each camera by pressing a predetermined button (e.g., a button) of a keyboard, or to automatically operate the camera focus adjustment function upon activation.

When the adjustment of the focus of the camera is completed, the processor 140 controls an angle or brightness of the corresponding camera to make a scratch more clearly visible through a lighting brightness adjustment function for distinguishing a sharpness of a scratch when the scratch is detected from the product (S108).

Here, the lighting brightness adjustment function for distinguishing the sharpness of the scratch is a function for ensuring that a camera image of a scratch can be captured well, and is a function for finding an optimal illuminance value by increasing the light brightness by a predetermined unit brightness (e.g., 50 lx) starting from a predetermined unit brightness (e.g., 200 lx) up to a maximum brightness (e.g., 3,500 lx) using a dimming function of the lighting to change the light brightness.

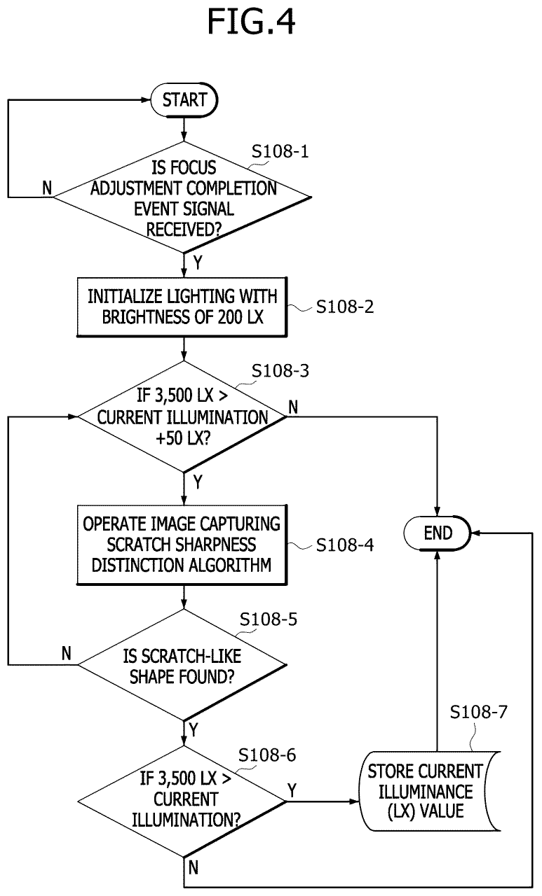

FIG. 4 is a flowchart for describing detailed operations of performing a lighting brightness adjustment function for distinguishing a sharpness of a scratch in FIG. 2.

Referring to FIG. 4, when the processor 140 receives a focus adjustment completion event signal (Y of S108-1), the processor 140 initializes lighting with a default brightness (e.g., 200 lx) (S108-2).

After the processor 140 initializes the lighting with the default brightness (e.g., 200 lx), when the brightness (current illumination of the lighting) is less than or equal to the maximum brightness (e.g., 3,500 lx), the processor 140 increases the unit brightness (e.g., 50 lx) (S108-3) and operates an image capturing scratch sharpness distinction algorithm.

When the processor 140 performs the lighting brightness adjustment function for distinguishing the sharpness of the scratch, the processor 140 may use a normal/abnormal distinction algorithm that is pre-learned using an image data model comparison function, which is a higher function of the image capturing scratch sharpness distinction algorithm (S108-4).

However, the present invention is not limited to this algorithm.

When a scratch-like shape is found (Y of S108-5), the processor 140 stores a current illumination as an optimal brightness, determines that the product is a defective product containing a scratch, and terminates this process.

More specifically, when the scratch-like shape is not found (N of S108-5) and the current illuminance is greater than or equal to the maximum brightness (e.g., 3,500 lx) (N of S108-3), the processor 140 determines that the product is a normal product without scratches and terminates this process.

Further, when the scratch-like shape is found (Y of S108-5) and the current illuminance is less than the maximum brightness (e.g., 3,500 lx) (Y of S108-6), the processor 140 stores a current illuminance value (i.e., a lx value) in a memory (not illustrated) and terminates this process (S108-7).

However, when the scratch-like shape is not found (N of S108-5), the processor 140 increases the unit brightness (e.g., 50 lx) again and operations S103-3 to S108-5 may be repeated.

Referring to FIG. 2 again, the processor 140 collects the images output from the plurality of cameras (i.e., n cameras) through an image data collection function and stores the images in the memory (not illustrated) (S109 to S110).

Here, the concept of a memory (not illustrated) includes a hard disk, a solid-state drive (SSD), a random access memory (RAM), a read-only memory (ROM), a cloud storage, etc.

The processor 140 performs normal data learning to generate an image data model that extracts abnormal data (S111 and S112).

For example, the image data model may be generated by improving the algorithm performance based on an end-to-end autonomous driving model (UniAD) algorithm. However, the present invention is not limited to the method of generating the image data model.

The processor 140 compares a plurality of pieces of image data (i.e., n pieces of image data) newly input to the image data model through the image data model comparison function to determine whether the molded product surface is normal or abnormal (S113).

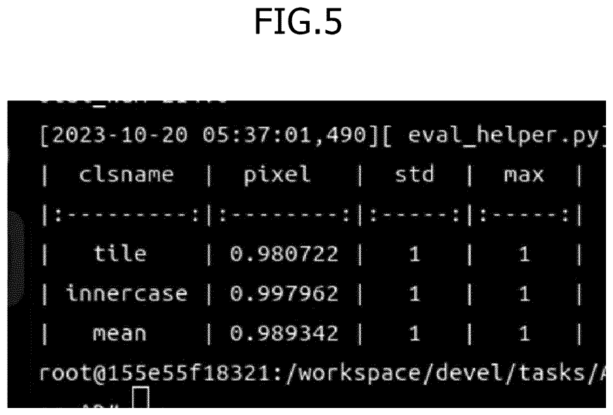

For reference, according to the test, as illustrated in FIG. 5, the determination performance of this algorithm was shown to be 99.79%.

When the processor 140 determines that the molded product surface is abnormal through the image data model comparison operation (Y of S114), the processor 140 displays the abnormality on a monitoring device (e.g., a user monitor) (S115), causes a product check and determination function to be performed by a worker (S116), and when the processor 140 determines that the molded product surface is abnormal (N of S114), terminates the inspection process.

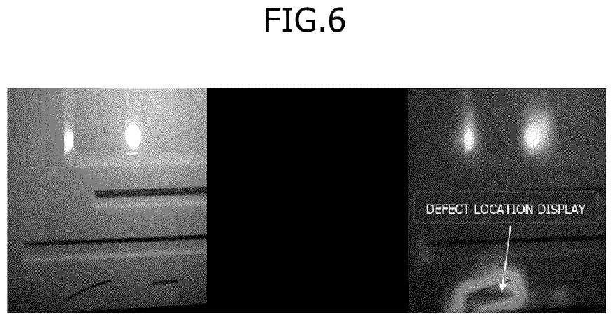

In operation S115 of displaying the abnormality on the monitoring device (e.g., the user monitor), the processor 140 displays a location of the defect with a predetermined color (e.g., red) in a region in which the abnormality (defect) has occurred, as shown in FIG. 6, and thus allows the worker to visually recognize rapidly and easily where and what type of defect has occurred in the product.

The product check and determination function performed by the worker refers to a function in which the worker, who has confirmed the location of the defect with the abnormality display function on a screen of a previous worker, to visually check and determine whether an actual defect has occurred in the product.

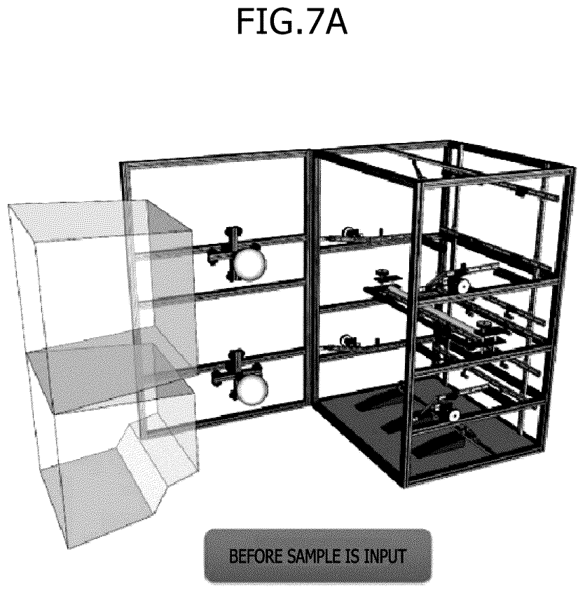

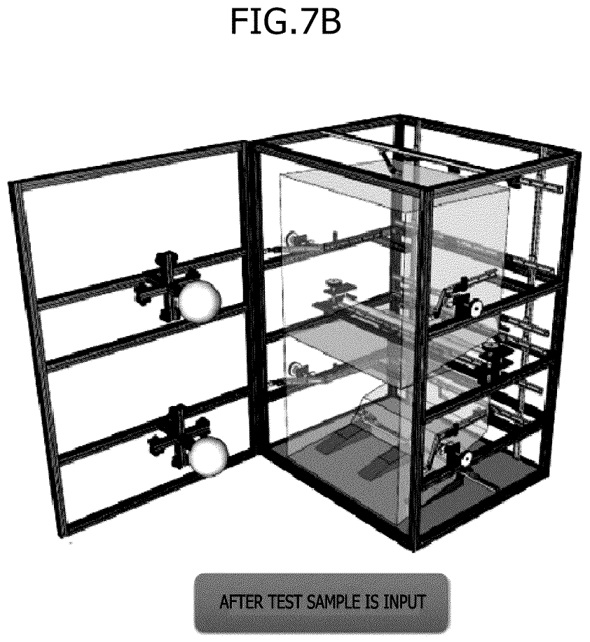

FIGS. 7A and 7B are a set of exemplary diagrams showing shapes of a device of the molded product surface defect measuring apparatus (i.e., an inspector) according to the present embodiment in FIG. 1.

FIG. 7A is an exemplary diagram showing a molded product (i.e., a sample) that is not yet input into an inspection device, and FIG. 7B is an exemplary diagram showing the molded product (i.e., the sample) that was input into the inspection device. A lighting module 120 and a camera module 130 are attached to a device (or a frame) of a molded product surface defect measuring apparatus 100 (i.e., an inspector) using the inspection device.

For example, one inspection device is formed on each of upper and lower portions of the device (or the frame) so that two inspection devices are attached, and eight cameras are attached to each device so that 16 cameras are all attached. Further, a plurality of lights, such as light bulbs, light emitting-diodes (LEDs), stick-shaped lights, etc., that emit light to the inside of each inspection device are attached to control brightness of the inside of the molded product.

However, the present invention is not limited to an external shape of the device (or the frame) of the molded product surface defect measuring apparatus 100 (i.e., the inspector) and the shape and number of the inspection devices attached thereto, and the size and shape of the device of the molded product surface defect measuring apparatus 100 may be modified to correspond to the size and shape of the product to be inspected.

In this case, the inspection devices may be designed with more than 10 axes so that the inspection devices can move up/down, leftward/rightward, or forward/backward, an entire body can move leftward/rightward, and the lights can move forward/backward, and may be adjusted automatically/manually.

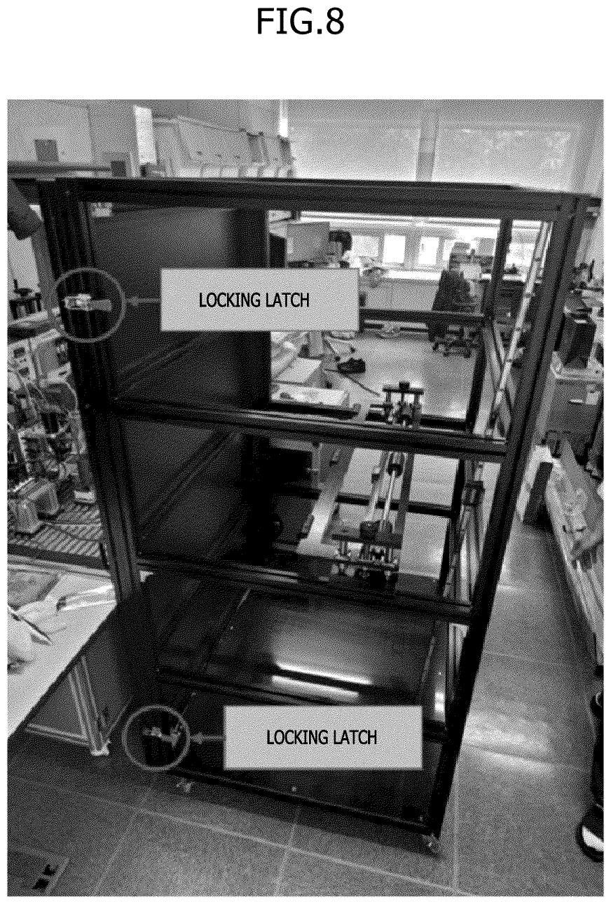

FIG. 8 is an exemplary diagram showing a double-locking latch device for closing and locking a door of a molded product surface defect measuring apparatus (i.e., an inspector) according to one embodiment of the present invention.

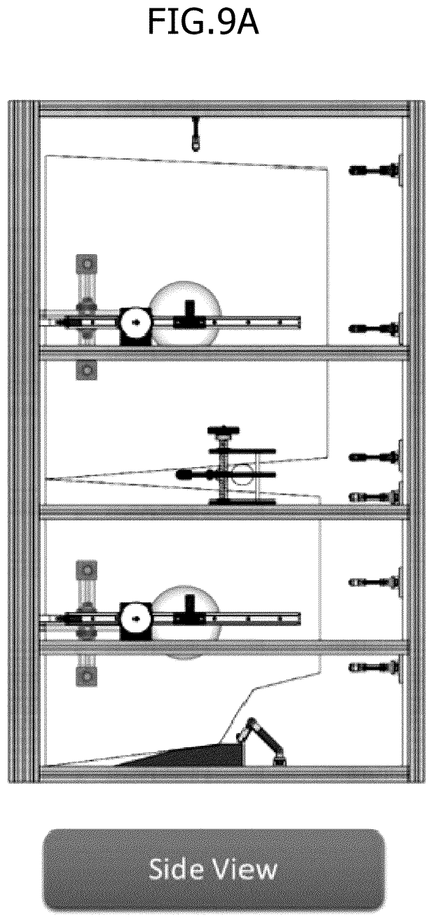

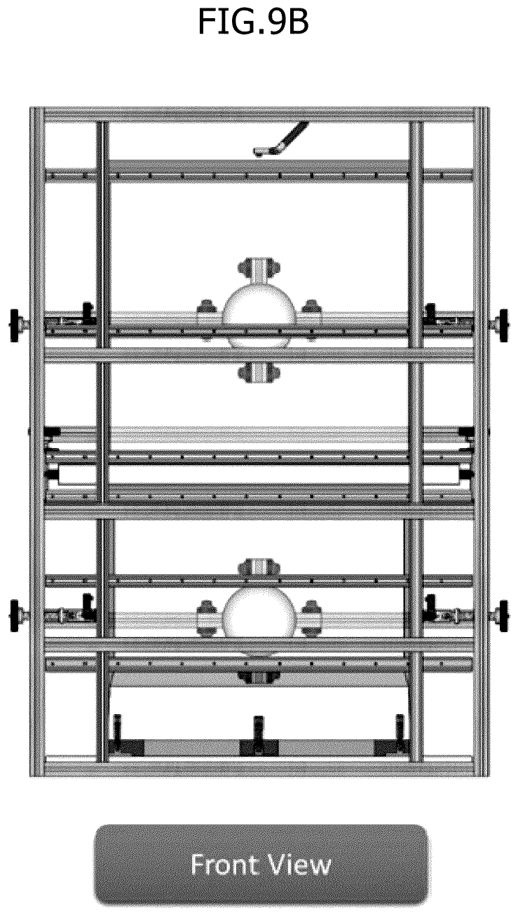

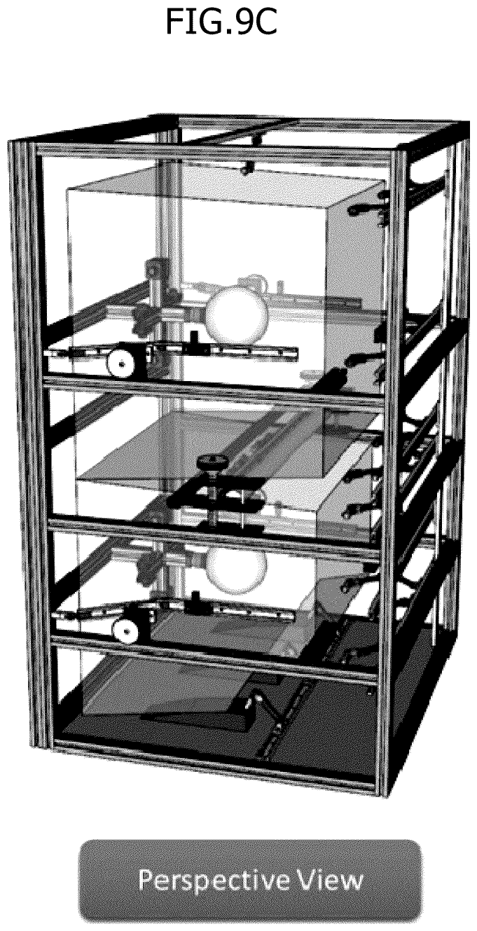

FIGS. 9A to 9C are a set of exemplary diagrams showing views at respective locations in a state in which the door of the molded product surface defect measuring apparatus (i.e., the inspector) is closed and a sample is input according to one embodiment of the present invention.

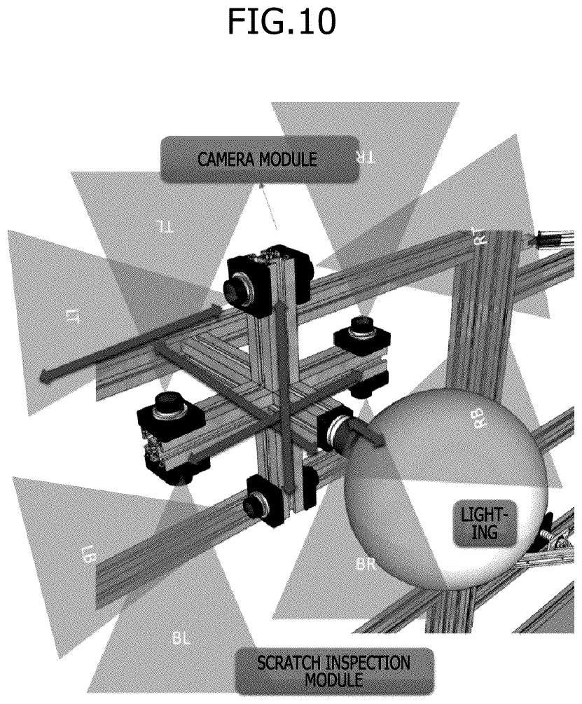

FIG. 10 is an exemplary diagram showing the shape of the device of the molded product surface defect measuring apparatus in more detail in FIGS. 7A and 7B and, in particular, is an exemplary diagram showing a shape of a scratch inspection device that facilitates scratch inspection.

For example, in the case of a product (e.g., a refrigerator plastic molded product), scratches in a front region of the device that is in the consumer's line of sight should be measured, and thus a depth of the scratch inspection device is adjusted to allow the locations of the upper/lower and left/right cameras to be moved and changed, and each camera may also be moved and changed to a desired photographing region. Each camera photographs its own designated location.

Here, T stands for a top, L stands for a left, R stands for a right, and B stands for a bottom.

TL denotes a left of a top, TR denotes a right of the top, LT denotes a top of a left, LB denotes a bottom of the left, RT denotes a top of a right, RB denotes a bottom of the right, BL denotes a left of a bottom, and BR denotes a right of a bottom, and thus a total of eight points may be photographed simultaneously.

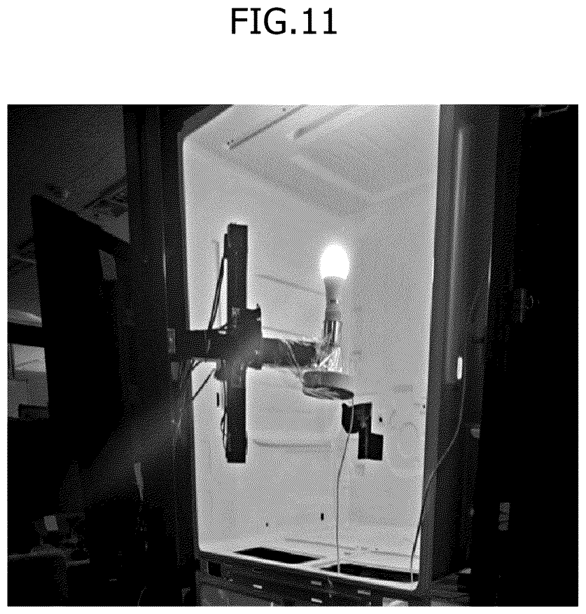

FIG. 11 is an exemplary picture showing a scene in which a defect in a surface of an actual molded product is measured in FIGS. 7A and 7B.

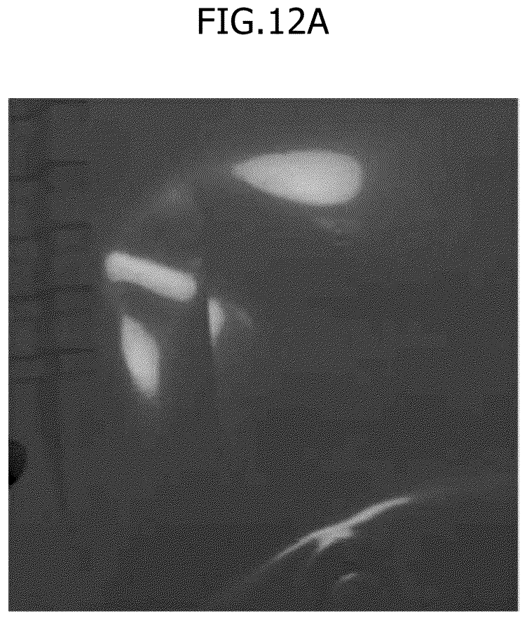

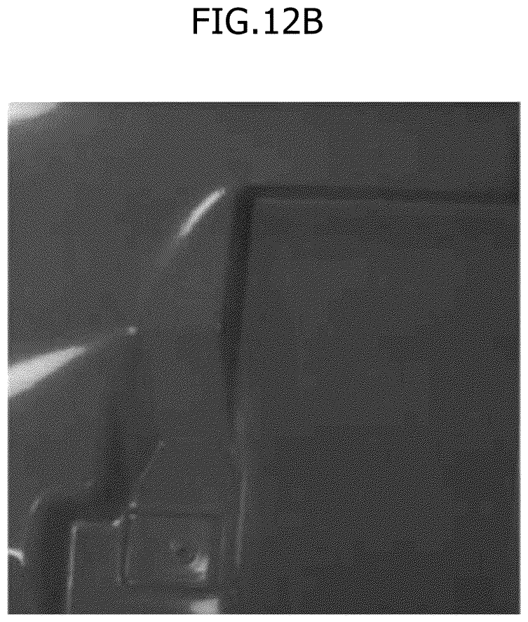

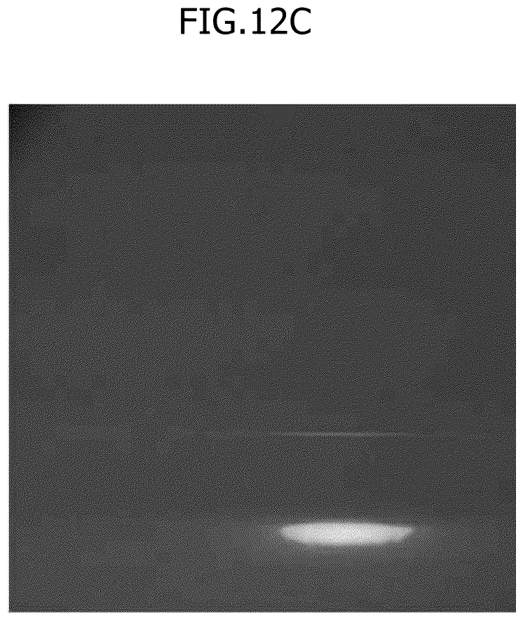

FIGS. 12A to 12C are a set of exemplary pictures showing a phenomenon in which emitted light spreads when a defect in a surface of a molded product is measured. In FIGS. 12A to 12C, a white portion of a surface of a refrigerator shows a phenomenon in which light is reflected by a lighting. FIGS. 12A to 12C are a set of exemplary diagrams for describing the fact that the surface of the refrigerator may appear defective due to light scattering of the lighting.

In order to prevent the light scattering phenomenon of the light, in the present embodiment, a bulb-type light and a directional LED light are also used together.

For example, an internal material of the refrigerator molded product is a plastic glossy mold that reflects light well, and thus, when the light is reflected, the light scattering phenomenon may be mis-recognized as a defect in the molded product surface, and thus the lighting plays an important role.

Therefore, a directional light should be used so that light is not directly emitted onto the camera.

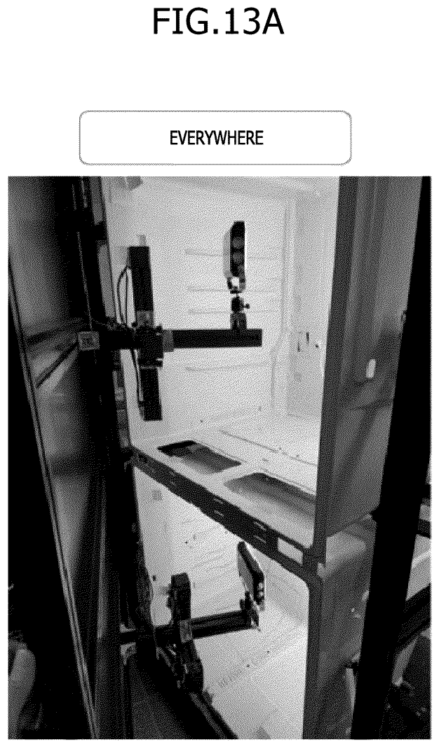

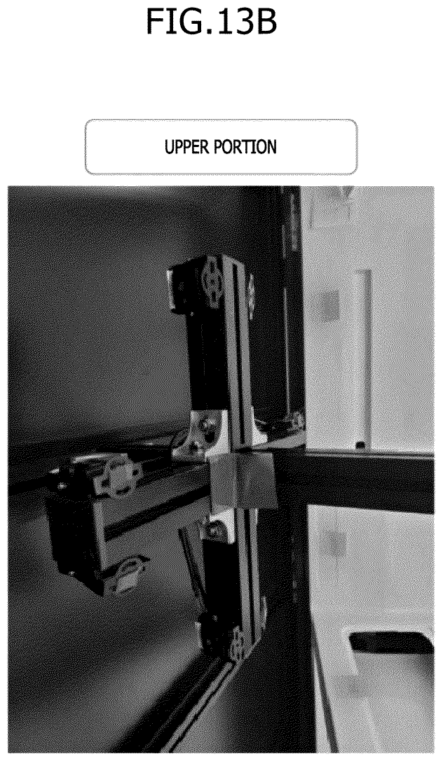

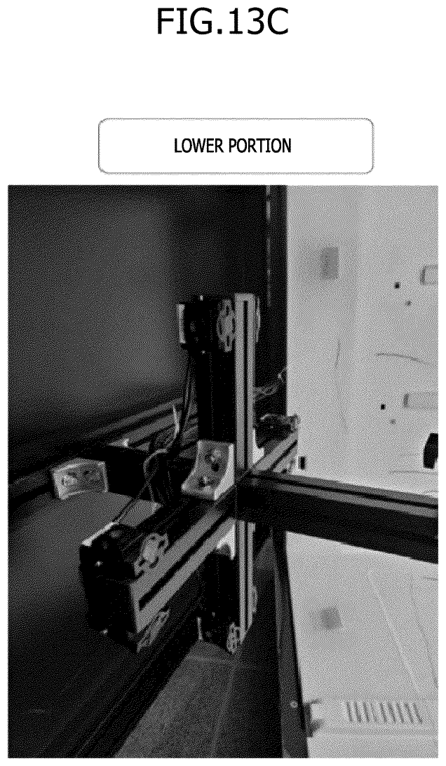

FIGS. 13A to 13C are a set of exemplary pictures at multiple angles showing scenes in which LED lights attached to the scratch inspection device emit light to the inside of the product in FIG. 10.

FIGS. 13A to 13C shows an actual detailed configuration of LED lights attached to a scratch inspection device. The scratch inspection device includes two devices that are one upper device and one lower device, and each device includes eight vision sensors, i.e., the total number of vision sensors is 16.

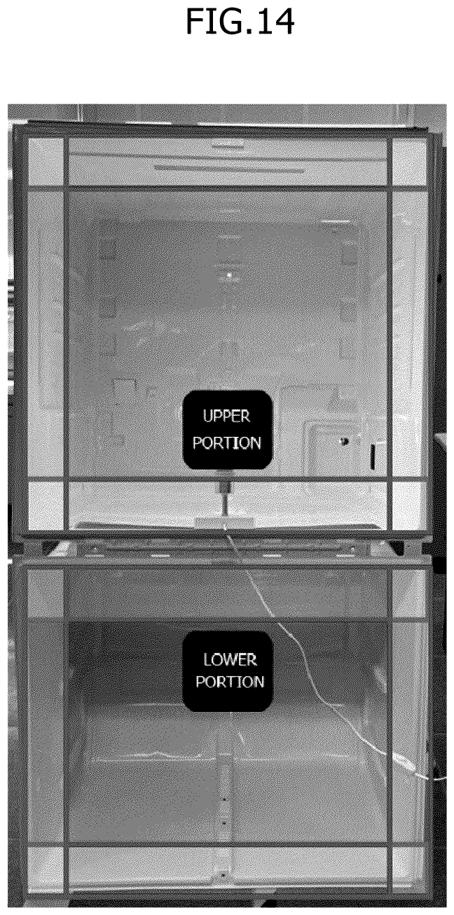

FIG. 14 is an exemplary diagram showing a location of the scratch inspection device to take a picture inside the refrigerator in FIG. 10.

In FIG. 14, the inside of the refrigerator is provided with shelves except for edge portions, and thus the presence or absence of scratches on the edge portions is determined and detected as the top priority. It can be said that this is the region that catches the eye first when the refrigerator door is opened and is also related to consumer emotional quality.

Currently, workers' quality inspection is not objective and is subjective in that the workers visually determine whether a product is normal or not while light is emitted.

Accordingly, the subsequent processes cause greater damage to the factory.

Therefore, the present embodiment has an effect of improving productivity by enabling objective, concise, and rapid production quality check by enabling defect detection from images obtained by photographing the inner surface of the refrigerator one time and is advantageous for commercialization because the present embodiment reflects the requirements of the field. Further, the present embodiment has an effect of allowing 16 surfaces to be photographed at the same time for fine scratches that are difficult to visually check and rapidly checking results of image analysis.

The present invention has an effect of enabling measurement of a defect in a molded product surface, which is generated during a molding process in a production line within a factory, according to objective criteria.

While the present invention has been described with reference to embodiments illustrated in the accompanying drawings, the embodiments should be considered in a descriptive sense only, and it should be understood by those skilled in the art that various alterations and other equivalent embodiments may be made.

Therefore, the scope of the present invention should be defined by only the following claims. Further, implementations described herein may be implemented, for example, as a method, a process, a device, a software program, a data stream, or a signal. Although discussed only in the context of a single form of implementation (e.g., only as a method), implementations of the features discussed may also be implemented in other forms (e.g., devices or programs). The device may be implemented as appropriate hardware, software, firmware, etc. The method may be implemented in a device such as a processor, which is generally a processing device including a computer, microprocessor, integrated circuit, or programmable logic device.

What is claimed is:

1. A molded product surface defect measuring apparatus comprising:
a sensor module configured to detect a signal for performing a door closing/opening event or a lighting-on/off event of the molded product surface defect measuring apparatus;
a lighting module configured to emit light required for measuring a defect in a surface of a molded product;
a camera module configured to photograph the surface of the molded product; and
a processor configured to control the lighting module and the camera module to perform the measuring of the defect in the surface of the molded product.

2. The molded product surface defect measuring apparatus of claim 1, wherein the product is input into the molded product surface defect measuring apparatus by a robot, a machine, or a facility.

3. The molded product surface defect measuring apparatus of claim 1, wherein, when the product is completely input into the molded product surface defect measuring apparatus and a door of the molded product surface defect measuring apparatus is closed, the molded product surface defect measuring apparatus receives a door closing event signal from the sensor module and controls the lighting module.

4. The molded product surface defect measuring apparatus of claim 1, wherein, when the product is completely input into the molded product surface defect measuring apparatus, the processor controls the lighting module and the camera module to emit light on the surface of the molded product, photograph the surface of the molded product using one or more cameras, extract data, and at the same time, determine whether the surface of the molded product is normal or abnormal through data analysis.

5. The molded product surface defect measuring apparatus of claim 1, wherein the processor is configured to:
perform a lighting-on function of the lighting module to support the photographing of the camera module by emitting light on an inner surface of the product;
activate a surface defect inspection function; and
operate the camera module to adjust a focus of each camera.

6. The molded product surface defect measuring apparatus of claim 5, wherein, in order to adjust the focus of each camera, the processor receives a predetermined button of a keyboard from a user as an input or activates the surface defect inspection function, and at the same time, automatically operates a camera focus adjustment function.

7. The molded product surface defect measuring apparatus of claim 1, wherein, when adjustment of a focus of each camera of the camera module is completed and a scratch is detected from the product, the processor controls the scratch to be more clearly photographed by adjusting an angle of each camera or adjusting light brightness through a lighting brightness adjustment function for distinguishing a sharpness of the scratch.

8. The molded product surface defect measuring apparatus of claim 7, wherein the lighting brightness adjustment function for distinguishing the sharpness of the scratch is a function for adjusting the light brightness in order to ensure that a camera image of the scratch is captured well, and is a function in which the processor uses a dimming function of lighting to find an optimal illuminance value by increasing the light brightness by a predetermined unit brightness starting from a predetermined default brightness up to a maximum brightness.

9. The molded product surface defect measuring apparatus of claim 7, wherein the processor is configured to:
collect image data through the camera module;
then perform normal data learning to generate an image data model that extracts abnormal data; and
compare a plurality of pieces of image data newly input to the image data model through an image data model comparison function to determine whether the molded product surface is normal or abnormal.

10. The molded product surface defect measuring apparatus of claim 1, wherein the processor displays an abnormality on a monitoring device so that a worker performs a product check and determination process when it is determined that the molded product surface is abnormal through the image data model comparison operation, and terminates the inspection process when it is determined that the molded product surface is normal,
wherein, when displaying the abnormality on the monitoring device, the processor displays a location of the defect with a predetermined color in a region in which the abnormality has occurred so that the worker visually recognizes rapidly and easily where and what type of defect has occurred in the product.

11. The molded product surface defect measuring apparatus of claim 1, wherein, in the lighting module, in order to prevent a light scattering phenomenon of lighting from being mis-recognized as the defect in the molded product surface when the defect in the surface of the molded product is measured, a bulb-type light and a directional light are used together.

12. A molded product surface defect measuring method comprising:
detecting, by a processor of a molded product surface defect measuring apparatus, a signal for performing a door closing/opening event or a lighting-on/off event of the molded product surface defect measuring apparatus using a sensor module; and
controlling a lighting module and a camera module to perform measurement of a defect in a surface of a molded product when the signal is detected using the sensor module.

13. The molded product surface defect measuring method of claim 12, wherein, in the controlling of the lighting module, when the product is completely input into the molded product surface defect measuring apparatus and a door of the molded product surface defect measuring apparatus is closed, the processor receives a door closing event signal from the sensor module and controls the lighting module.

14. The molded product surface defect measuring method of claim 12, wherein, when the product is completely input into the molded product surface defect measuring apparatus, the processor controls the lighting module and the camera module to emit light on the surface of the molded product, photograph the surface of the molded product using one or more cameras, extract data, and at the same time, determine whether the surface of the molded product is normal or abnormal through data analysis.

15. The molded product surface defect measuring method of claim 12, wherein, in the controlling of the lighting module and the camera module, the processor is configured to:
perform a lighting-on function of the lighting module to support the photographing of the camera module by emitting light on an inner surface of the product;
activate a surface defect inspection function; and
operate the camera module to adjust a focus of each camera.

16. The molded product surface defect measuring method of claim 15, wherein, in order to adjust the focus of each camera, the processor receives a predetermined button of a keyboard from a user as an input or activates the surface defect inspection function, and at the same time, automatically operates a camera focus adjustment function.

17. The molded product surface defect measuring method of claim 12, wherein, when adjustment of a focus of each camera of the camera module is completed and a scratch is detected from the product, the processor controls the scratch to be more clearly photographed by adjusting an angle of each camera or adjusting light brightness through a lighting brightness adjustment function for distinguishing a sharpness of the scratch.

18. The molded product surface defect measuring method of claim 17, wherein the lighting brightness adjustment function for distinguishing the sharpness of the scratch is a function for adjusting the light brightness in order to ensure that a camera image of the scratch is captured well, and is a function in which the processor uses a dimming function of lighting to find an optimal illuminance value by increasing the light brightness by a predetermined unit brightness starting from a predetermined default brightness up to a maximum brightness.

19. The molded product surface defect measuring method of claim 17, wherein, in the controlling of the lighting module and the camera module to perform the measurement of the defect in the surface of the molded product, the processor is configured to:
collect image data through the camera module;
then perform normal data learning to generate an image data model that extracts abnormal data; and
compare a plurality of pieces of image data newly input to the image data model through an image data model comparison function to determine whether the molded product surface is normal or abnormal.

20. The molded product surface defect measuring method of claim 12, wherein in the controlling of the lighting module and the camera module to perform the measurement of the defect in the surface of the molded product,
the processor displays an abnormality on a monitoring device so that a worker performs a product check and determination process when it is determined that the molded product surface is abnormal through the image data model comparison operation, and terminates the inspection process when it is determined that the molded product surface is normal,
wherein, when displaying the abnormality on the monitoring device, the processor displays a location of the defect with a predetermined color in a region in which the abnormality has occurred so that the worker visually recognizes rapidly and easily where and what type of defect has occurred in the product.
